(19) United States
(12) Patent Application Publication
(10) Pub. No.: US 2026/0047556 A1
(43) Pub. Date: Feb. 19, 2026

(54) Lease for Dog

(71) Applicant: Mark Andrew Schwan, Nelson (CA)

(72) Inventor: Mark Andrew Schwan, Nelson (CA)

(21) Appl. No.: 19/301,030

(22) Filed: Aug. 15, 2025

Related U.S. Application Data
(60) Provisional application No. 63/684,475, filed on Aug. 19, 2024.

(51) Int. Cl. A01K 27/00

(52) U.S. Cl. CPC A01K 27/003

(57) ABSTRACT

A leash for a dog includes a leash structure having a first end and a second end. The leash structure includes a first portion extending from the first end towards the second end and including an outer sleeve and a rigid rod arranged inside the outer sleeve. Moreover, the leash structure includes a second portion extending from the first portion to the second portion and defining a loop structure at the second end to facilitate a holding of the leash by a user. The second portion is a flexible portion.

### CROSS-REFERENCE TO RELATED APPLICATIONS

This application claims the benefit of U.S. Provisional Patent Application No. 63/684,475 filed Aug. 19, 2024.

### BACKGROUND OF THE INVENTION

The present disclosure relates, generally, to a leash for a dog, and more particularly relates to a leash having a stiff leash portion that prevents entanglement of the leash with a body of the dog.

While walking the dog, the leash can tangle with the legs of the dog, creating inconvenience to the dog walker as the leash needs to be untangled to prevent any injury to the dog.

### SUMMARY OF THE INVENTION

In one aspect of the disclosure, a leash for a dog is disclosed. The leash includes a leash structure having a first end and a second end. The leash structure includes a first leash portion extending from the first end towards the second end, and has a sleeve and a rigid rod arranged inside the sleeve. The leash structure includes a second leash portion extending from the first leash portion to the second end. The second leash portion facilitates a holding of the leash by a user and is a flexible portion.

In some additional, alternative, and optional embodiments, the second leash portion defines a loop structure adapted to be held by the user.

In some additional, alternative, and optional embodiments, the leash further includes a hook attached to the leash structure and arranged at the first end of the leash structure to secure the leash structure to a collar of the dog.

In some additional, alternative, and optional embodiments, the leash further includes a belt removably engaged to the leash structure and adapted to be secured to the user to enable an engagement of the leash with the user.

In some additional, alternative, and optional embodiments, the leash further includes a coupler having a first connector attached to the second leash portion and a second connector attached to the belt and adapted to be removably engaged with the first connector to removably secure the belt with the leash structure.

In some additional, alternative, and optional embodiments, the belt includes a first strap portion adapted to be removably secured to the user to removably engage the belt to the user, and a second strap portion attached to the first strap portion and adapted to be removably engage with the leash structure to removably secure the belt with the leash structure.

In some additional, alternative, and optional embodiments, the belt includes an engagement structure to removably secure the first strap portion to the user.

In some additional, alternative, and optional embodiments, the engagement structure includes a first buckle attached to one end of the first strap portion and a second buckle attached to another end of the first strap portion. The second buckle is adapted to be removably engage with the first buckle to removably secure the first strap portion to the user.

### BRIEF DESCRIPTION OF DRAWINGS

FIG. 1 illustrates a leash having a leash structure attached to a collar arranged around a neck of a dog with a stiff leash portion extending from the collar and a flexible leash portion being held by a person, in accordance with an embodiment of the disclosure;

FIG. 2 illustrates a top perspective view of the leash of FIG. 1 depicting a rod arranged inside a sleeve of the stiff leash portion, in accordance with an embodiment of the disclosure;

FIG. 3 illustrates a leash with a belt secured to the leash structure with belt secured around a waist of a dog walker in accordance with an embodiment of the disclosure;

FIG. 4 illustrates a zoom view of a portion of the FIG. 3 depicting an engagement structure that secure the belt around the waist of the dog walker in accordance with an embodiment of the disclosure; and

FIG. 5 illustrates the engagement structure of the belt depicting a first buckle and a second buckle disengaged from the first buckle, in accordance with an embodiment of the disclosure.

### DETAILED DESCRIPTION OF THE INVENTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

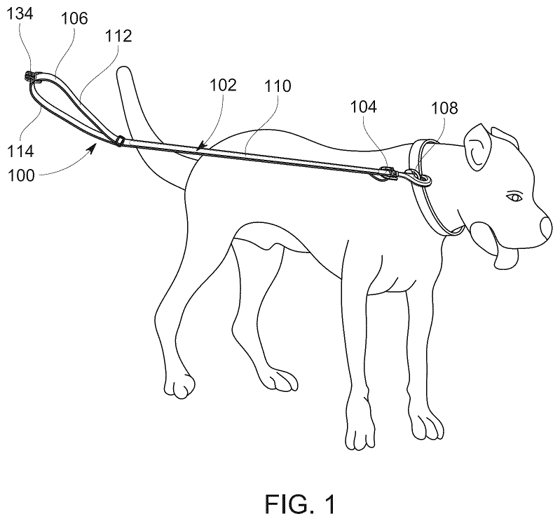

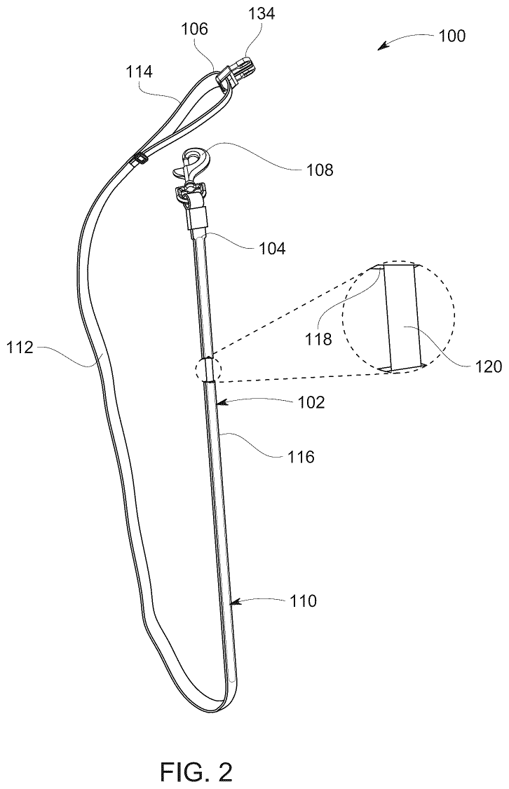

Referring to FIG. 1, a leash 100 removably attached to a collar 200 arranged around a neck or a torso of a dog is shown. Referring to FIGS. 1 and 2, the leash 100 includes a leash structure 102 having a first end 104 and a second end 106, and a hook 108 attached to the leash structure 102 and arranged at the first end 104 of the leash structure 102. The hook 108 enables the removably connection/engagement of the leash 100 to the collar 200 attached to the dog. It may be appreciated the hook 108 may include any connection structure known in the art and suitable to engage a leash with a collar of the dog.

Further, the leash structure 102 includes a first leash portion 110 i.e., stiff leash portion 110, extending from the first end 104 towards the second end 106 and a second leash portion 112 i.e., flexible leash portion 112, extending from the first leash portion 110 to the second end 106. The second leash portion 112 is a flexible leash similar to a rope, a cord, or a strap and defines a loop structure x to facilitate a holding of the leash 100 by a person.

As shown in FIGS. 1 and 2, the first leash portion 110 is a stiff leash having a sleeve 116 having a tubular structure defining an elongated channel 118 and a rigid rod 120 arranged inside the sleeve 116. It may be noted that the ends of the sleeve 116 are closed ends to prevent any removal of the rod 120 from the sleeve 116. In some embodiments, both ends of the sleeve 116 are stitched to define the closed ends of the sleeve 116. In some embodiments, the sleeve 116 is a tubular webbing made of a flexible material, such as, but not limited to, hemp, nylon, polyurethane, or any other similar material known in the art. Also, the rod 120 is made of a rigid material, such as, but not limited to, fiberglass, composite plastic, wood, metal, or any other similar material known in the art. In some embodiments, the rod 120 is made of light weight material to keep the weight of the leash structure relatively less. In some embodiments, the rod 120 may be a thin plate.

The stiff leash 110 acts as a leverage point from the dog collar 200 or harness and prevents slack in the leash 100 which typically crosses under the dog legs creating entanglement. As the first leash portion 110 of the leash structure 102 is stiff/rigid, the leash provides good control of the dog neck and torso, and hence enables a two handed leverage point for the handler to control the animal. With the leash 100 attached to the dog, people no longer need to stop during their walks and untangle the leash under the dog's legs, creating a much more enjoyable walking experience for dog and human.

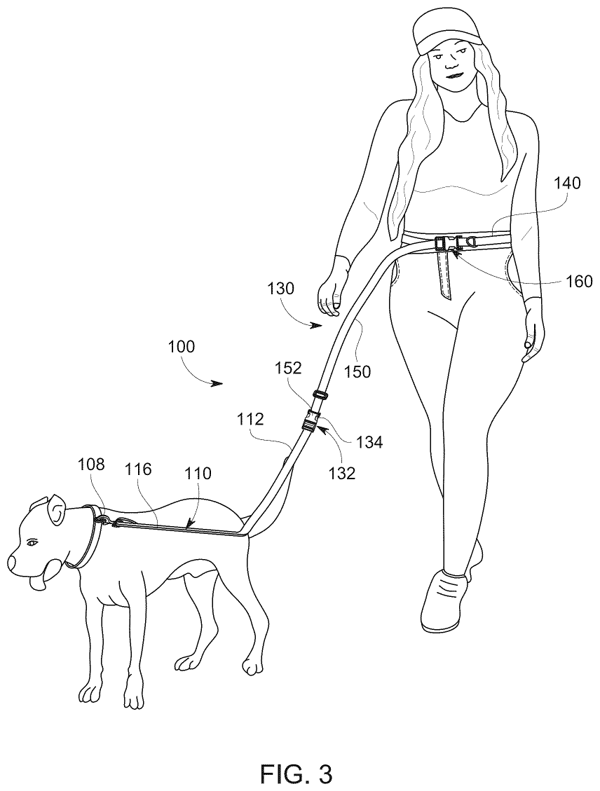

In some embodiments, as shown in FIGS. 3 to 5, the leash 100 includes a belt 130 removably attached to the leash structure 102 and adapted to secured to a torso or waist of the person/dog walker. To facilitate the removably engagement of the belt 130 with the leash structure 102, the leash 100 includes a coupler 132 having a first connector 134, best shown in FIGS. 1 and 2, attached to the leash structure 102 and arranged at the second end 106 of the leash structure 102. In the embodiment, the coupler 132 is a snap connector, a quick release buckle, or any other connector that facilitates an attachment the leash structure 102 with the belt 130.

Referring again to FIGS. 3 to 5, the belt 130 includes a first strap portion 140 adapted to be arranged around a waist of the person and a second strap portion 150 attached to the first strap portion 140 and adapted to be engage with the leash structure 102. To facilitate the removable engagement of the second strap portion 150 with the leash structure 104, a connector, for example, a second connector 152, shown in FIG. 3, of the coupler 132 is attached to the second strap portion 150. The second connector 152 removably engages with the first connector 132 to enable removable engagement of the leash structure 102 with the belt 130. In the embodiments, the second connector 152 is female buckle having a groove, while the first connector 134 is a male buckle having fingers adapted for insertion inside the groove of the female buckle to engage the first connector 134 and the second connector 152.

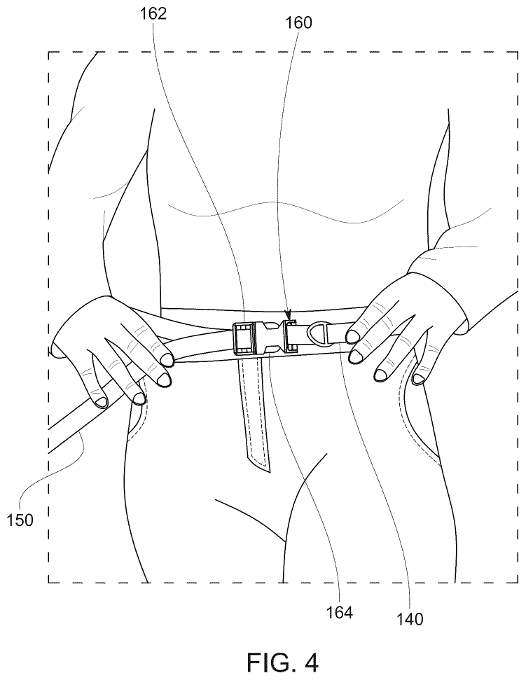

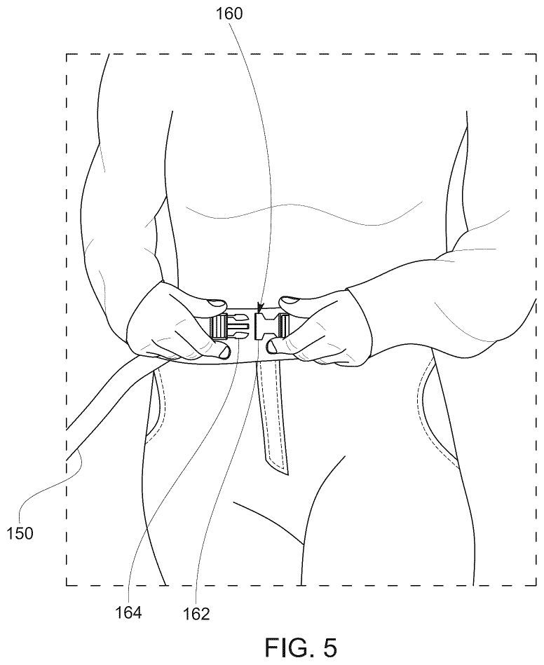

Further, referring to FIGS. 4 and 5, to removably secure the first strap portion 140 around the waist of the person/dog walker, the belt 132 includes an engagement structure 160 having a first buckle 162 and a second buckle 164 attached to the first strap portion 140. In the embodiments, the first buckle 162 is female buckle having a groove, while the second buckle 164 is a male buckle having fingers adapted for insertion inside the groove of the female buckle to engage the first buckle 162 with the second buckle 164. In the embodiments, the first and second strap portions 140, 150 may be made of a flexible material, such as, but not limited to, hemp, nylon, polyurethane, or any other similar material known in the art. In some embodiments, the strap portions 140, 150 may webbing straps.

Although the disclosure has been described in connection with a preferred embodiment, it should be understood that modifications, additions and alterations may be made to the disclosure by one skilled in the art without departing from the spirit and scope of the disclosure.

It should be understood that the foregoing description is only illustrative of the aspects of the disclosed embodiments. Various alternatives and modifications can be devised by those skilled in the art without departing from the aspects of the disclosed embodiments.

1. A leash for a dog, the leash comprising:
a leash structure having a first end and a second end, the leash structure comprises
a first leash portion extending from the first end towards the second end and including a sleeve and a rigid rod arranged inside the sleeve, and
a second leash portion extending from the first leash portion to the second end to facilitate a holding of the leash by a user, wherein the second portion is a flexible portion.

2. The leash of claim 1, wherein the second leash portion defines a loop structure adapted to be held by the user.

3. The leash of claim 1 further comprising a hook attached to the leash structure and arranged at the first end of the leash structure to secure the leash structure to a collar of the dog.

4. The leash of claim 1 further comprising a belt removably engaged to the leash structure and adapted to be secured to the user to enable an engagement of the leash with the user.

5. The leash of claim 4 further comprises a coupler having a first connector attached to the second leash portion and a second connector attached to the belt and adapted to be removably engaged with the first connector to removably secure the belt with the leash structure.

6. The leash of claim 4, wherein the belt includes a first strap portion adapted to be removably secured to the user to removably engage the belt to the user, and a second strap portion attached to the first strap portion and adapted to be removably engage with the leash structure to removably secure the belt with the leash structure.

7. The leash of claim 6, wherein the belt comprises an engagement structure to removably secure the first strap portion to the user.

8. The leash of claim 7, wherein the engagement structure comprises a first buckle attached to one end of the first strap portion and a second buckle attached to another end of the first strap portion and adapted to be removably engage with the first buckle to removably secure the first strap portion to the user.
